(19) United States
(12) Patent Application Publication
(10) Pub. No.: US 2026/0239012 A1
(43) Pub. Date: Aug. 13, 2026

(54) ADAPTABLE MEDIA ACCESS CONTROL ADDRESS ROTATION INTERVALS

(71) Applicant: Cisco Technology, Inc., San Jose, CA (US)

(72) Inventors: Robert E. BARTON, Richmond (CA); Jerome HENRY, Pittsboro, NC (US); Malcolm M. SMITH, Richardson, TX (US)

(21) Appl. No.: 19/177,433

(22) Filed: Apr. 11, 2025

Related U.S. Application Data
(60) Provisional application No. 63/757,560, filed on Feb. 12, 2025.

(51) Int. Cl. H04W 12/108; H04W 12/122

(52) U.S. Cl. CPC H04W 12/108; H04W 12/122

(57) ABSTRACT

Described herein is a system that adjusts how frequently devices rotate MAC addresses. A wireless access point includes one or more memories and one or more processors communicatively coupled to the one or more memories. The one or more processors, individually or collectively, perform an operation that includes assigning a user device to a first group such that the user device rotates a MAC address of the user device based on an epoch duration of the first group, determining that a network security threat level increased, and in response to the network security threat level increasing, reducing the epoch duration to a reduced epoch duration such that the user device rotates the MAC address based on the reduced epoch duration.

### CROSS-REFERENCE TO RELATED APPLICATIONS

This application claims benefit of co-pending United States provisional patent application Serial No. 63/757,560 filed February 12, 2025. The aforementioned related patent application is herein incorporated by reference in its entirety.

### TECHNICAL FIELD

Embodiments presented in this disclosure generally relate to wireless communication. More specifically, embodiments disclosed herein media access control (MAC) address rotation for wireless communication.

### BACKGROUND

User devices may connect to wireless access points to access a Wi-Fi network. The devices may use MAC addresses as a form of identification on the network. To improve security and privacy, the devices may rotate or change their MAC addresses at certain times.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates an example access point or device in the system of FIG. 1A.

FIG. 2 illustrates an example operation performed by the system of FIG. 1A.

FIG. 3 illustrates an example operation performed by the system of FIG. 1A.

FIG. 4 illustrates an example operation performed by the system of FIG. 1A.

FIG. 5 illustrates an example operation performed by the system of FIG. 1A.

FIG. 6 is a flowchart of an example method performed by the system of FIG. 1A.

FIG. 7 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### OVERVIEW

The present disclosure describes a system that adjusts how frequently devices rotate MAC addresses. According to an embodiment, a wireless access point includes one or more memories and one or more processors communicatively coupled to the one or more memories. The one or more processors, individually or collectively, perform an operation that includes assigning a user device to a first group such that the user device rotates a MAC address of the user device based on an epoch duration of the first group, determining that a network security threat level increased, and in response to the network security threat level increasing, reducing the epoch duration to a reduced epoch duration such that the user device rotates the MAC address based on the reduced epoch duration.

According to another embodiment, a method includes assigning, by a wireless access point, a user device to a first group such that the user device rotates a MAC address of the user device based on an epoch duration of the first group, determining, by the wireless access point, that a network security threat level increased, and in response to the network security threat level increasing, reducing, by the wireless access point, the epoch duration to a reduced epoch duration such that the user device rotates the MAC address based on the reduced epoch duration.

According to another embodiment, a device includes one or more memories and one or more processors communicatively coupled to the one or more memories. The one or more processors, individually or collectively, perform an operation that includes receiving, from a wireless access point, a message indicating an epoch duration is reduced to a reduced epoch duration based on an increase to a network security threat level and rotating a MAC address based on the reduced epoch duration.

### EXAMPLE EMBODIMENTS

In Wi-Fi networks, user devices may use media access control (MAC) addresses as a form of identification. To improve security and privacy, a user device may rotate (e.g., change) its MAC address periodically. In existing networks, however, the user devices may rotate MAC addresses at fixed time intervals, even when MAC address rotation may be unnecessary (e.g., due to network security and privacy being relatively high). As a result, these MAC address rotations may incur computational cost with little to no benefit, effectively wasting the processing resources of the network.

The present disclosure describes a network that adjusts the frequency at which user devices rotate MAC addresses. For example, the network may assign user devices to different groups, with each group rotating MAC addresses according to different epoch durations. The network may monitor the activities on the network to determine a network security threat level. When the network security threat level increases (e.g., due to the appearance of a malicious actor or due to the detection of suspicious behavior), the network may reduce the epoch duration for a group of user devices. As a result, that group of user devices may begin rotating MAC addresses more frequently. Conversely, when the network security threat level decreases (e.g., due to the malicious actor leaving the network or due to suspicious behavior ceasing), the network may increase the epoch duration for the group, which causes the user devices to rotate MAC addresses less frequently.

In certain embodiments, the network provides several technical advantages. For example, by adjusting the epoch duration according to the network security threat level, the network reduces waste of the user devices’ processing resources spent rotating MAC addresses. As another example, the network improves the security and privacy of the user devices when the network security threat level increases.

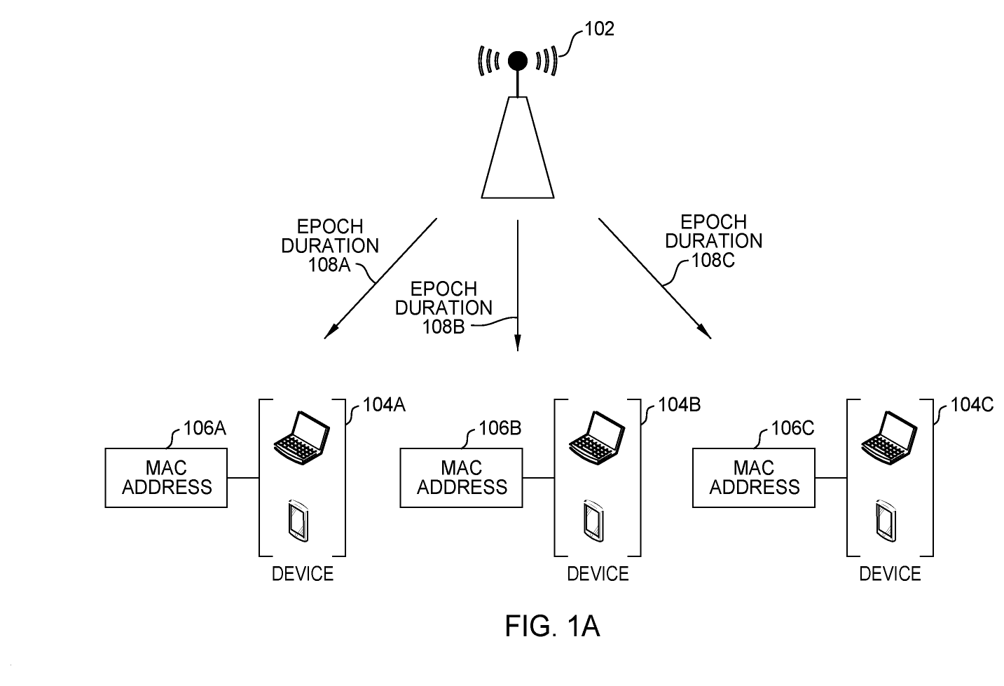

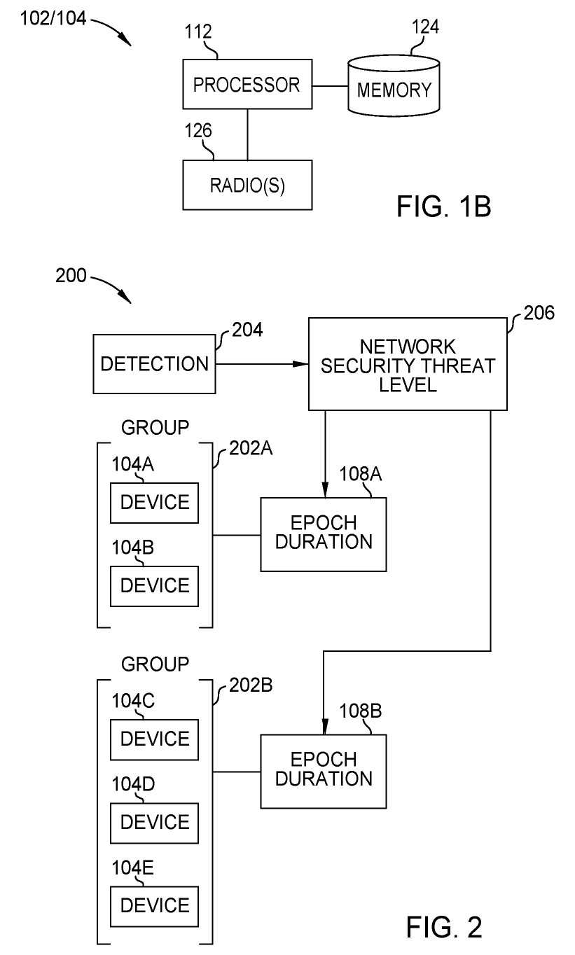

FIG. 1A illustrates an example system 100, which may be a network deployment that provides wireless communication (e.g., Wi-Fi communications). As seen in FIG. 1A, the system 100 includes an access point 102 and multiple devices 104 (which may also be referred to as client devices). Generally, the access point 102 determines a network security threat level and instructs the devices 104 how frequently to rotate MAC addresses based on the network security threat level.

The access point 102 may be a network device that facilitates wireless communication (e.g., Wi-Fi communication) in the system 100. A device 104 connects to the access point 102, and the access point 102 my facilitate communication to and from the device 104. For example, the access point 102 may receive messages from the device 104 and direct those messages towards their destination. As another example, the access point 102 may receive messages intended for the device 104 and direct those messages to the device 104. The access point 102 may also exchange messages with other access points 102.

The device 104 may be any suitable device that wirelessly connects to an access point 102. As an example and not by way of limitation, the device 104 may be a computer, a laptop, a wireless or cellular telephone, an electronic notebook, a personal digital assistant, a tablet, or any other device capable of receiving, processing, storing, or communicating information with other components of the system 100. The device 104 may be a wearable device such as a virtual reality or augmented reality headset, a smart watch, or smart glasses. The device 104 may also include a user interface, such as a display, a microphone, keypad, or other appropriate terminal equipment usable by the user. The device 104 may include a hardware processor, memory, or circuitry configured to perform any of the functions or actions of the device 104 described herein. For example, a software application designed using software code may be stored in the memory and executed by the processor to perform the functions of the device 104.

In the example of FIG. 1A, the system 100 includes the devices 104A, 104B, and 104C. Each of the devices 104A, 104B, and 104C uses a MAC address 106. For example, the devices 104A, 104B, and 104C may use a MAC address 106 as a form of identification and/or authentication on the network. As seen in FIG. 1A, the devices 104A, 104B, and 104C use the MAC addresses 106A, 106B, and 106C, respectively. To improve privacy and/or security on the network, the devices 104A, 104B, and 104C may rotate or change the MAC addresses 106A, 106B, and 106C periodically. By rotating or changing the MAC addresses 106A, 106B, and 106C, it becomes more difficult to determine which of the devices 104A, 104B, or 104C transmitted a message if that message were intercepted by a malicious actor. When multiple devices 104 rotate or change MAC addresses 106 at the same time, it becomes even more difficult to determine which of the devices 104 transmitted a message if that message were intercepted.

The access point 102 may control how frequently the devices 104 rotate MAC addresses 106. Generally, the access point 102 may assign the devices 104 into groups, and the access point 102 may assign each of the devices 104 in a group a time interval, which may be referred to as an epoch. Each epoch has an epoch duration 108 set by the access point 102. When an epoch for a group ends (e.g., when a timer with the epoch duration 108 for the epoch expires), the devices 104 assigned to that group rotate or change MAC addresses 106. Each group may have an epoch with a different epoch duration 108. In the example of FIG. 1A, the device 104A belongs to a group with an epoch duration 108A, the device 104B belongs to a group with an epoch duration 108B, and the device 104C belongs to a group with an epoch duration 108C. These epoch durations 108A, 108B, and 108C may be different from each other. The device 104A may rotate the MAC address 106A according to the epoch duration 108A. The device 104B may rotate the MAC address 106B according to the epoch duration 108B. The device 104C may rotate the MAC address 106C according to the epoch duration 108C.

The access point 102 may determine a network security threat level that indicates how vulnerable the network is to malicious activity, which may jeopardize the devices 104 in the network. For example, the network security threat level may be a numerical value that the access point 102 increases or decreases depending on the vulnerabilities that the access point 102 detects or determines on the network. The access point 102 may consider any type of information when determining the network security threat level. The information may be determined or detected by the access point 102 and/or a separate security system, such as a vulnerability management system. As an example, the information may include the general environment in which the network is deployed (e.g., public venue, private/corporate space, etc.), the nature of the data communicated on the network (e.g., whether the data is likely to include personally identifiable information, whether a personal or guest service set identifier is used, etc.), presence of foreign or rogue access points (e.g., capable of spoofing or misleading devices 104), reported network attacks (e.g., man in the middle attacks, MAC spoofing attacks, denial of service attacks, etc.), unauthorized probing of the network, discovery of new vulnerabilities, key vulnerabilities (e.g., validity of encryption keys).

As an example, the access point 102 may determine a network security threat level as a numerical value from 1 to 6. A value of 1 may indicate the highest network security threat level, and a value of 6 may indicate the lowest network security threat level. For example, a value of 6 may indicate that no threats are detected. If the access point 102 determines or detects a normal level of security threats, then the access point 102 may increase the network security threat level using a value of 5. If the access point 102 determines or detects a heightened or larger level of security threats, then the access point 102 may increase the network security threat level using a value of 4. If the access point 102 determines that attacks are possible, then the access point 102 may increase the network security threat level using a value of 3. If the access point 102 determines that attacks are likely, then the access point 102 may increase the network security threat level using a value of 2. If the access point 102 determines that attacks are underway or imminent, then the access point 102 may increase the network security threat level using a value of 1. Conversely, the access point 102 may decrease the network security threat level when the access point 102 determines or detects that attacks or security threats are stopping.

The access point 102 may adjust one or more epoch durations 108 in response to increasing or decreasing network security threat levels. For example, when the access point 102 increases the network security threat level (e.g., due to detecting an attack or new threat), the access point 102 may reduce the epoch duration 108 for one or more groups of devices 104. As a result, these devices 104 may rotate MAC addresses 106 more frequently, which may increase privacy and/or security for these devices 104. When the access point 102 decreases the network security threat level (e.g., due to detecting an attack or threat stopping), the access point 102 may increase the epoch duration 108 for one or more groups of devices 104. As a result, these devices 104 may rotate MAC addresses 106 less frequently, which may conserve processing and network resources that would otherwise be wasted rotating MAC addresses unnecessarily. The access point 102 may communicate updated epoch durations 108 to the corresponding devices 104. In the example of FIG. 1A, the access point 102 communicates the epoch duration 108A to the device 104A, the epoch duration 108B to the device 104B, and the epoch duration 108C to the device 104C. The devices 104A, 104B, and 104C may then rotate or change MAC addresses according to the epoch durations 108A, 108B, and 108C.

FIG. 1B illustrates an example access point 102 or device 104 of the system 100 of FIG. 1A. As seen in FIG. 1B, the access point 102 and/or device 104 include a processor 122, a memory 124, and one or more radios 126.

The processor 122 is any electronic circuitry, including, but not limited to one or a combination of microprocessors, microcontrollers, application specific integrated circuits (ASIC), application specific instruction set processor (ASIP), and/or state machines, that communicatively couples to the memory 124 and controls the operation of the access point 102 and/or device 104. The processor 122 may be 8-bit, 16-bit, 32-bit, 64-bit or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 122 may include other hardware that operates software to control and process information. The processor 122 executes software stored on the memory 124 to perform any of the functions described herein. The processor 122 controls the operation and administration of the access point 102 and/or device 104 by processing information (e.g., information received from the memory 124 and radios 126). The processor 122 is not limited to a single processing device and may encompass multiple processing devices contained in the same device or computer or distributed across multiple devices or computers.The processor 122 is considered to perform a set of functions or actions if the multiple processing devices collectively perform the set of functions or actions, even if different processing devices perform different functions or actions in the set.

The memory 124 may store, either permanently or temporarily, data, operational software, or other information for the processor 122. The memory 124 may include any one or a combination of volatile or non-volatile local or remote devices suitable for storing information. For example, the memory 124 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 124, a disk, a CD, or a flash drive. In particular embodiments, the software may include an application executable by the processor 122 to perform one or more of the functions described herein. The memory 124 is not limited to a single memory and may encompass multiple memories contained in the same device or computer or distributed across multiple devices or computers. The memory 124 is considered to store a set of data, operational software, or information if the multiple memories collectively store the set of data, operational software, or information, even if different memories store different portions of the data, operational software, or information in the set.

The radios 126 may communicate messages or information using different communication technologies. For example, the access point 102 and/or device 104 may use one or more of the radios 126 for Wi-Fi communications. The access point 102 and/or device 104 may use one or more of the radios 126 to transmit messages and one or more of the radios 126 to receive messages. The access point 102 and/or device 104 may include any number of radios 126 to communicate using any number of communication technologies.

FIG. 2 illustrates an example operation 200 performed by the system 100 of FIG. 1A. Generally, an access point (e.g., the access point 102 shown in FIG. 1A) performs the operation 200. By performing the operation 200, the access point adjusts the epic duration of devices based on a network security threat level.

The access point begins by assigning devices 104 that are connected to or associated with the access point to groups 202. The access point may assign the devices 104 to groups 202 according to any factor. For example, the access point may assign a device 104 to a group 202 to balance the number of devices 104 between or amongst groups 202. As another example, the access point may assign a device 104 to a group 202 according to a location or a proximity of the device 104 to other devices 104 in the group 202. As another example, the access point may assign a device 104 to a group 202 according to similarities between the device 104 and other devices 104 in the group 202. In the example of FIG. 2, the access point assigns the devices 104A and 104B to the group 202A, and the access point assigns the devices 104C, 104D, and 104E to the group 202B.

Each group 202 may have a different epoch duration 108. As explained previously, the epoch duration 108 for a group 202 controls how frequently the devices 104 in that group 202 rotate or change MAC addresses. Generally, the shorter the epoch duration 108, the more frequently the devices 104 in a group 202 rotate or change MAC addresses. In the example of FIG. 2, the group 202A has an epoch duration 108A, and the group 202B has an epoch duration 108B. Thus, the devices 104A and 104B rotate or change MAC addresses according to the epoch duration 108A, and the devices 104C, 104D, and 104E rotate or change MAC addresses according to the epoch duration 108B. The devices 104A and 104B may rotate or change MAC addresses at the same time, and the devices 104C, 104D, and 104E may rotate or change MAC addresses at the same time. Additionally, the epoch durations 108A and 108B may be different from each other. As a result, the devices 104A and 104B have a different MAC address rotation schedule than the devices 104C, 104D, and 104E.

In some embodiments, the access point maintains a default or starting group 202 to which all devices 104 are initially assigned when the devices 104 first connect to or associate with the access point. Afterwards, the devices 104 may be moved or assigned to other groups 202. For example, the group 202A may be a default or starting group to which the devices 104A, 104B, 104C, 104D, and 104E are initially assigned. The access point may then move the devices 104C, 104D, and 104E to the group 202B (e.g., in response to requests from the devices 104C, 104D, and 104E to move to a different group).

The access point may make a detection 204 of a change that affects a network security level 206. For example, the access point may detect a new security threat or that an attack is more likely to occur. In response, the access point may increase the network security threat level 206. As another example, the access point may detect that a security threat has stopped or that an attack is no longer likely to occur. In response, the access point may decrease the network security threat level 206.

The access point may adjust the epoch duration 108A and/or 108B based on the network security threat level 206. As the access point increases or decreases the network security threat level, the access point may make corresponding changes to the epoch duration 108A and/or 108B. For example, if the network security threat level 206 increases, the access point may reduce the epoch duration 108A and/or the epoch duration 108B such that the devices 104A and 104B and/or the devices 104C, 104D, and 104E rotate or change MAC addresses more frequently. Conversely, if the network security threat level 206 decreases, the access point may increase the epoch duration 108A and/or the epoch duration 108B such that the devices 104A and 104B and/or the devices 104C, 104D, and 104E rotate or change MAC addresses less frequently.

In some instances, the access point may adjust some epoch durations 108 without adjusting other epoch durations 108. For example, depending on the change to the network security threat level 206, the access point may adjust the epoch duration 108A without adjusting the epoch duration 108B, and vice versa. In this manner, the access point may adjust the epoch durations 108 for different groups 202 separately.

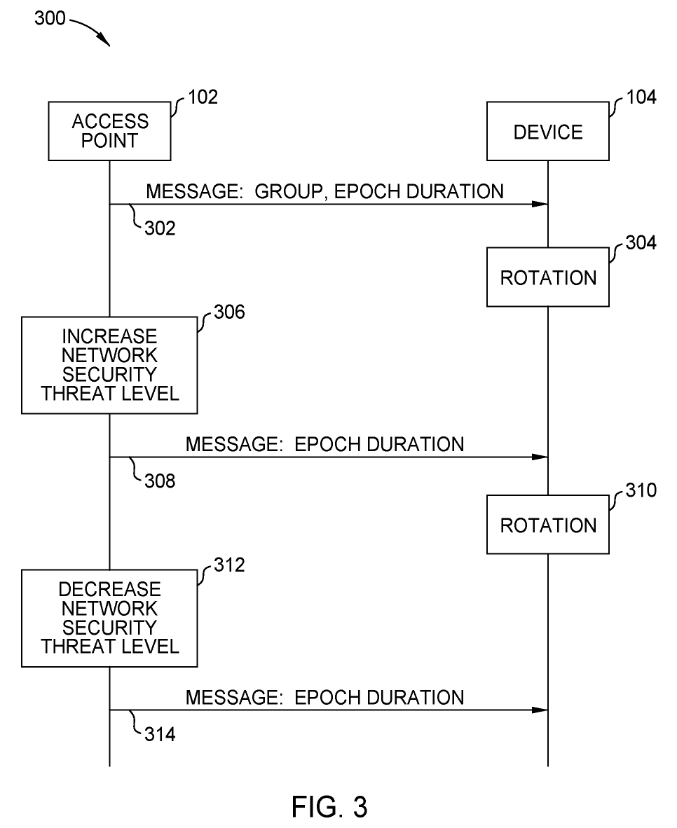

FIG. 3 illustrates an example operation 300 performed by the system 100 of FIG. 1A. Generally, the access point 102 and the device 104 perform the operation 300. By performing the operation 300, the access point 102 and the device 104 adjust an epoch duration for the device 104.

At 302, the access point 102 communicates a message to the device 104. The message may indicate a group to which the device 104 is assigned. Additionally, the message may indicate an epoch duration for the group. By communicating the message to the device 104, the access point 102 may inform the device 104 (and other devices 104 assigned to the same group) of the epoch duration for the group. After receiving the message, the device 104 may set the epoch duration such that the device 104 rotates or changes a MAC address of the device 104 according to the epoch duration.

At 304, the device 104 rotates the MAC address of the device 104. For example, the device 104 may have set a timer to the epoch duration in the message. When the timer expires, the device 104 may determine that the end of the epoch has been reached. In response, the device 104 rotates or changes the MAC address of the device 104. Other devices 104 assigned to the same group also rotate MAC addresses at this time. The device 104 may rotate or change the MAC address any number of times. For example, after the timer expires, the device 104 may reset the timer to the epoch duration. When the timer expires again, the device 104 may rotate or change the MAC address again. This process may continue until the access point adjusts the epoch duration.

At 306, the access point 102 detects a change that causes an increase to the network security threat level. For example, the access point 102 may detect a new security threat or may determine that an attack is more likely to occur. In response the access point 102 increases the network security threat level. When the network security threat level increases, the access point may determine that the device 104 should rotate the MAC address more frequently to improve security and/or privacy. In response, the access point may reduce the epoch duration for the device 104 and/or for the group to which the device 104 is assigned. At 308, the access point 102 communicates a message to the device 104. The message indicates the reduced epoch duration.

The device 104 receives the message and sets the epoch duration as the reduced epoch duration. For example, the device 104 may set the timer to the reduced epoch duration. When the timer expires, the device 104 may determine that the end of the epoch has been reached. At 310, the device 104 rotates the MAC address according to the reduced epoch duration. Generally, the device 104 will rotate the MAC address more frequently as a result of the reduced epoch duration.

At 312, the access point 102 detects a change that causes a decrease to the network security threat level. For example, the access point 102 may detect that a security threat has stopped or may determine that an attack is less likely to occur. In response the access point 102 decreases the network security threat level. When the network security threat level decreases, the access point may determine that the device 104 may rotate the MAC address less frequently. In response, the access point may increase the epoch duration for the device 104 and/or for the group to which the device 104 is assigned. At 314, the access point 102 communicates a message to the device 104. The message indicates the increased epoch duration.

The device 104 receives the message and sets the epoch duration as the increased epoch duration. For example, the device 104 may set the timer to the increased epoch duration. When the timer expires, the device 104 may determine that the end of the epoch has been reached. The device 104 rotates the MAC address according to the increased epoch duration. Generally, the device 104 will rotate the MAC address less frequently as a result of the increased epoch duration.

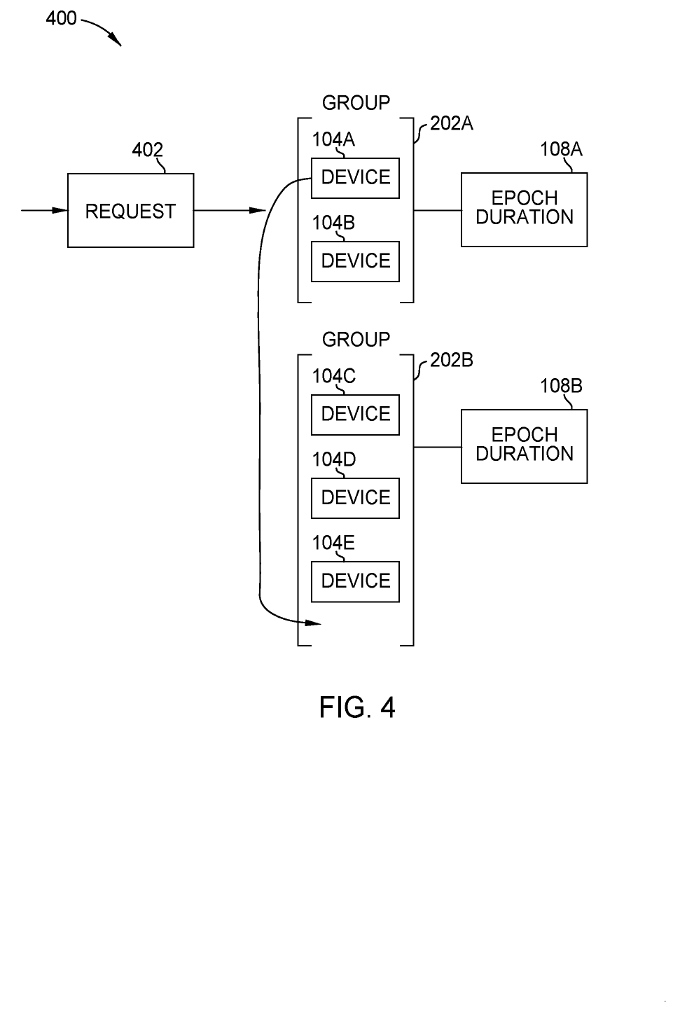

FIG. 4 illustrates an example operation 400 performed by the system 100 of FIG. 1A. Generally, an access point (e.g., the access point 102 shown in FIG. 1A) performs the operation 400. By performing the operation 400, the access point assigns devices to different groups.

The access point begins by receiving a request 402 from a device to join a different group. For example, the device 104A assigned to the group 202A may have communicated the request 402 to join the group 202B. The device 104A may request to join the group 202B for any reason. For example, the device 104A may request to join the group 202B because the device 104A is more similar to the other devices 104 in the group 202B. As another example, the device 104A may request to join the group 202B because the device 104A is physically closer to the other devices 104 in the group 202B. As another example, the device 104A may request to join the group 202B because the device 104A is beginning to transmit or use personally identifiable information or other sensitive information, which may be better protected with a shorter epoch duration.

In response to the request 402, the access point may reassign the device 104A to the group 202B. By assigning the device 104A to the group 202B, the device 104A may begin rotating or changing a MAC address of the device 104A according to the epoch duration 108B of the group 202B rather than the epoch duration 108A of the group 202A. As a result, the devices 104 may request to join different groups 202 to rotate or change MAC addresses according to different epoch durations. Additionally, by joining a different group 202, the devices 104 may have epoch durations adjusted or changed by the access point in response to different amounts of change to the network security threat level.

The access point may adjust the epoch durations 108A and/or 108B before or after the reassignment of the device 104A. For example, the access point may increase or decrease the epoch durations 108A and/or 108B in response to changes to the network security threat level.

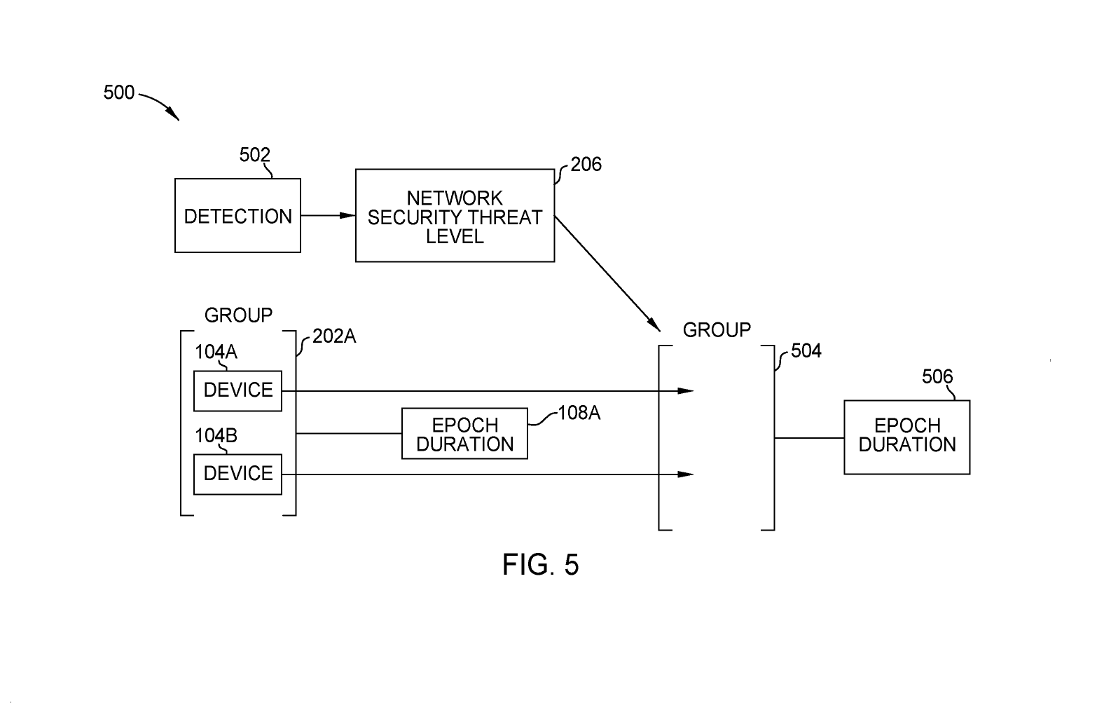

FIG. 5 illustrates an example operation 500 performed by the system 100 of FIG. 1A. Generally, an access point (e.g., the access point 102 shown in FIG. 1A) performs the operation 500. By performing the operation 500, the access point adjusts the epoch duration for devices in a group.

Generally, in some implementations, the access point may adjust the epoch duration that certain devices use by assigning the devices to different groups rather than by adjusting the epoch duration of the group to which the devices are assigned. In the example of FIG. 5, the access point begins by making a detection 502 that affects the network security threat level 206. For example, the detection 502 may cause an increase or decrease to the network security threat level 206.

The access point may determine that the devices 104A and 104B assigned to the group 202A should rotate or change MAC addresses according to a different epoch duration 108 as a result of the change to the network security threat level 206. Instead of adjusting the epoch duration 108A of the group 202A, the access point creates a group 504 with an epoch duration 506. The epoch duration 506 may be different from the epoch duration 108A. The access point then assigns or moves the devices 104A and 104B to the group 504. As a result, the devices 104A and 104B begin rotation or changing MAC addresses according to the epoch duration 506 rather than the epoch duration 108A.

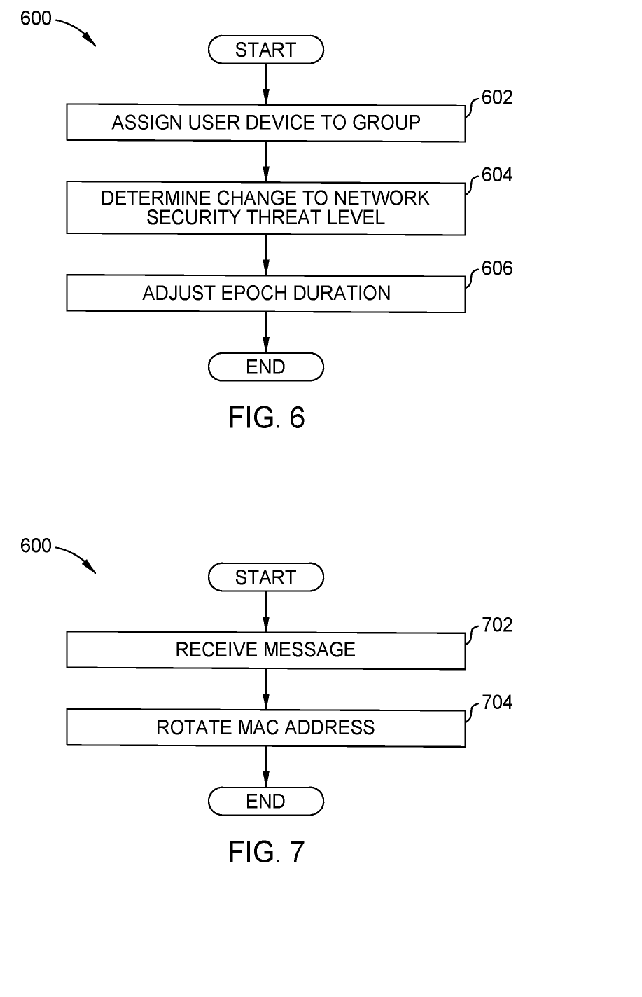

FIG. 6 is a flowchart of an example method 600 performed by the system 100 of FIG. 1A. In particular embodiments, an access point (e.g., the access point 102 shown in FIG. 1A) performs the method 600. By performing the method 600, the access point adjusts epoch durations for rotating MAC addresses based on a network security threat level.

At 602, the access point assigns a user device to a group. The access point may assign the user device to the group according to any factor or information. For example, the access point may assign the user device to the group based on a proximity or location of the user device. As another example, the access point may assign the user device to the group based on a type or operation of the user device.

At 604, the access point determines a change to a network security threat level. For example, the access point may detect a new security threat or may determine that an attack is more likely to occur. As a result, the access point may increase the network security threat level. As another example, the access point may detect that a security threat stopped or may determine that an attack is less likely to occur. As a result, the access point may decrease the network security threat level.

At 606, the access point adjusts an epoch duration of the group in response to the change to the network security threat level. For example, if the network security threat level increased, the access point may reduce the epoch duration for the group such that the device assigned to the group rotates a MAC address more frequently. As another example, if the network security threat level decreased, the access point may increase the epoch duration for the group such that the device assigned to the group rotates the MAC address less frequently.

FIG. 7 is a flowchart of an example method 700 performed by the system 100 of FIG. 1A. In certain embodiments, a user device (e.g., the device 104 shown in FIG. 1A) performs the method 700. By performing the method 700, the user device rotates or changes a MAC address according to an epoch duration.

At 702, the user device receives a message from an access point. The message may indicate a group to which the user device is assigned and an epoch duration for that group. The user device may set a timer to the epoch duration and run the timer.

At 704, the user device rotates the MAC address of the user device according to epoch duration. For example, the timer may expire signaling the end of the epoch. In response, the device rotates the MAC address. The device may then reset and run the timer. When the timer expires again, the device may rotate the MAC address again. In this manner, the device rotates the MAC address according to the epoch durations set by the access point.

In summary, an access point 102 adjusts the frequency at which user devices 104 rotate MAC addresses. For example, the access point 102 may assign user devices 104 to different groups, with each group rotating MAC addresses according to different epoch durations. The access point 102 may monitor the activities on the network to determine a network security threat level. When the network security threat level increases (e.g., due to the appearance of a malicious actor or due to the detection of suspicious behavior), the access point 102 may reduce the epoch duration for a group of user devices 104. As a result, that group of user devices 104 may begin rotating MAC addresses more frequently. Conversely, when the network security threat level decreases (e.g., due to the malicious actor leaving the network or due to suspicious behavior ceasing), the access point 102 may increase the epoch duration for the group, which causes the user devices 104 to rotate MAC addresses less frequently.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A wireless access point comprising:
one or more memories; and
one or more processors communicatively coupled to the one or more memories, the one or more processors configured to, individually or collectively, perform an operation comprising:
assigning a user device to a first group such that the user device rotates a media access control (MAC) address of the user device based on an epoch duration of the first group;
determining that a network security threat level increased; and
in response to the network security threat level increasing, reducing the epoch duration to a reduced epoch duration such that the user device rotates the MAC address based on the reduced epoch duration.

2. The wireless access point of claim 1, wherein the operation further comprises:
determining that the network security threat level decreased; and
in response to the network security threat level decreasing, increasing the reduced epoch duration.

3. The wireless access point of claim 1, wherein the operation further comprises communicating, to the user device, a message indicating the reduced epoch duration.

4. The wireless access point of claim 3, wherein communicating the message occurs after the user device rotates the MAC address based on the epoch duration.

5. The wireless access point of claim 1, wherein the operation further comprises:
receiving, from the user device, a request to join a second group; and
assigning, based on the request, the user device to the second group such that the user device rotates the MAC address based on a second epoch duration of the second group different from the epoch duration.

6. The wireless access point of claim 5, wherein the operation further comprises reducing the second epoch duration to a second reduced epoch duration based on the network security threat level increasing.

7. The wireless access point of claim 1, wherein the operation further comprises detecting at least one of a rogue access point, a network attack, or an unauthorized network probe and wherein determining that the network security threat level increased is based on detecting at least one of the rogue access point, the network attack or the unauthorized network probe.

8. The wireless access point of claim 1, wherein reducing the epoch duration occurs after the user device rotates the MAC address on the epoch duration.

9. A method comprising:
assigning, by a wireless access point, a user device to a first group such that the user device rotates a MAC address of the user device based on an epoch duration of the first group;
determining, by the wireless access point, that a network security threat level increased; and
in response to the network security threat level increasing, reducing, by the wireless access point, the epoch duration to a reduced epoch duration such that the user device rotates the MAC address based on the reduced epoch duration.

10. The method of claim 9, further comprising:
determining that the network security threat level decreased; and
in response to the network security threat level decreasing, increasing the reduced epoch duration.

11. The method of claim 9, further comprising communicating, to the user device, a message indicating the reduced epoch duration.

12. The method of claim 11, wherein communicating the message occurs after the user device rotates the MAC address based on the epoch duration.

13. The method of claim 9, further comprising:
receiving, from the user device, a request to join a second group; and
assigning, based on the request, the user device to the second group such that the user device rotates the MAC address based on a second epoch duration of the second group different from the epoch duration.

14. The method of claim 13, further comprising reducing the second epoch duration to a second reduced epoch duration based on the network security threat level increasing.

15. The method of claim 9, further comprising detecting at least one of a rogue access point, a network attack, or an unauthorized network probe and wherein determining that the network security threat level increased is based on detecting at least one of the rogue access point, the network attack or the unauthorized network probe.

16. The method of claim 9, wherein reducing the epoch duration occurs after the user device rotates the MAC address on the epoch duration.

17. A device comprising:
one or more memories; and
one or more processors communicatively coupled to the one or more memories, the one or more processors configured to, individually or collectively, perform an operation comprising:
receiving, from a wireless access point, a message indicating an epoch duration is reduced to a reduced epoch duration based on an increase to a network security threat level; and
rotating a MAC address based on the reduced epoch duration.

18. The device of claim 17, wherein the operation further comprises:
receiving, from the wireless access point, a message indicating the reduced epoch duration is increased to an increased epoch duration based on a decreased to the network security threat level; and
rotating the MAC address based on the increased epoch duration.

19. The wireless access point of claim 17, wherein the operation further comprises rotating the MAC address based on the epoch duration before receiving the message.

20. The wireless access point of claim 17, wherein the increase to the network security threat level is based on detection of at least one of a rogue access point, a network attack, or an unauthorized network probe.
